(19) United States
(12) Patent Application Publication
(10) Pub. No.: US 2009/0234725 A1
(43) Pub. Date: Sep. 17, 2009

(54) DIGITAL CONTENT AND HARD-GOODS EXCHANGE SYSTEM

(76) Inventor: Tomas Fisera, Zurich (CH)

Correspondence Address: MOETTELI & ASSOCIATES SARL, ST. LEONHARDSTRASSE 4, ST. GALLEN, CH-9000, CH

(21) Appl. No.: 12/046,561

(22) Filed: Mar. 12, 2008

(51) Int. Cl. G06Q 30/00

(52) U.S. Cl. 705/14

(57) ABSTRACT

A system and method for performing free or low cost online digital media download with coupons is disclosed. The system includes a digital media database, accessible to be downloaded by online customers for free, for a low or a bulk cost. Retailers/sponsors pay royalties to copyrightholders of the digital media, and supply coupons to a percentage of the online. Customers may redeem the coupons at retail establishments. The coupons may vary according to the demographic location of the customer, the selected digital media, and other criteria.

### FIELD OF THE INVENTION

This invention relates to online digital media downloads. More particularly, the invention relates to a system and method for low cost and legal distribution of digital media to online consumers.

### BACKGROUND OF THE INVENTION

The Internet is radically changing the way music, movies, and other forms of digital media, are created and distributed. Where once the electronic production of the digital media meant stamping the information onto a compact disc (CD) medium and selling the CDs at music stores, the Internet, or World Wide Web as it is commonly known, treats digital media much like other information being exchanged electronically, such as electronic mail, text, newspapers, journals, books, and the like. Like the traditional media, digital media is a series of binary bits, and may thus be transmitted and be accessible to “surfers” of the Web in similar fashion.

Though slow to react initially, the music and movie industries are acknowledging this paradigm shift. Record companies, for example, are providing web sites from which customers may download music (for a fee), obtain additional information about artists and albums, and procure other value-added features that nurture the connection between the artist and the music enthusiast.

Piracy is a paramount concern to the music and movie industries. The ability to easily make lossless copies of digital media, the once availability of free music download sites (which have since been shut down), and a general disdain for intellectual property rights has made it difficult to persuade people to pay very much for digital media. Such is particularly the case for young people, a big market for the music industry. Obviously, the music companies and movie industries, and the artists they represent, expect to be paid for the investments they have made in providing the digital media to a mass audience.

Attempts to satisfy both the digital media industries and the consumers of the digital media include web sites offering free and low-cost media downloads coupled with advertising. Typically, the advertisers are charged to advertise on the web site, with the proceeds used to pay royalties to the artists whose media are downloaded by the consumers. Or, the downloaded media content includes advertising that the consumer must watch before viewing the desired content. There are numerous examples on the Internet in which the downloadable media is bundled with the advertisement.

The opportunities for electronic commerce on the Internet are virtually without limit. The distribution of music, movies, and other digital media over a computer-implemented global network such as the Internet is a well-suited application of ecommerce, whereby consumers may easily and quickly find and purchase digital content, whether individual tracks or entire albums of music, as well as movies.

### SUMMARY OF THE INVENTION

A system and method for performing a digital content and hard-goods exchange, also known as a media download system and method, is disclosed. The media download system includes a digital media database, such as music or movies, the database being stored on a non-volatile medium, such as a hard disk drive. The digital content of the database is owned by a rightholder, such as a musician or producer. A retailer, sponsor, or a combination thereof, who pays a royalty to each rightholder, further supplies a coupon to a winning customer (selected consumer), the coupon being redeemable at a retail establishment. A customer accesses a web page on a network, such as the World Wide Web, selects the digital content from the database, and downloads the content to a computer, without paying a fee. The winning customer may redeem the coupon at a retail establishment, which may be a traditional, brick-and-mortar store or a retail web site. The coupons may be demographically diverse, issued according to the media being downloaded, and may conform to other selectable criteria.

### BRIEF DESCRIPTION OF THE DRAWINGS

FIG. 1 is a block diagram of a digital content and hard-goods exchange system, according to some embodiments.

FIG. 2 is a depiction of the customer perspective in the system of FIG. 1, according to some embodiments.

FIG. 3 is a depiction of the relationship between the retailer/sponsor and the copyrightholder, according to some embodiments.

FIG. 4 is a depiction of the mechanism used by the system of FIG. 1 for distributing coupons to customers, according to some embodiments.

FIG. 5 is a flow diagram of the method used by the system of FIG. 1, according to some embodiments.

### DETAILED DESCRIPTION OF THE PREFERRED EMBODIMENTS

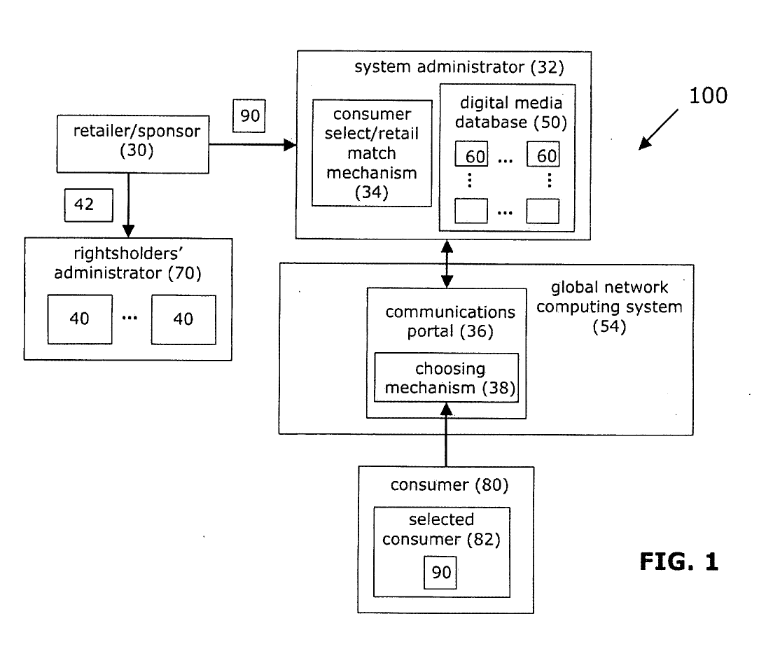

FIG. 1 is a block diagram of a digital content and hard-goods exchange system 100, also known herein as a media download system 100, according to some embodiments. The media download system 100 includes a system administrator 32, a consumer 80 (which also may be referred to herein as a customer 80), a rightsholders' administrator 70, and a retailer/sponsor 30. (Although single entities are depicted for simplicity, it is envisioned that the media download system 100 includes several administrators 70, retailers/sponsors 30, and consumers 80.) Using the media download system 100, the consumer 80 is able to obtain free, or at least low cost legal downloads of digital media, such as music or movies.

The system administrator 32 includes a digital media database 50, a communications portal 36, and a consumer select/retail match mechanism 34. The communications portal 36 may be part of the system administration, or distinct, as indicated in FIG. 1, such as where the communications portal is maintained by a third party. The digital media database 50 includes digital content 60, or digital media. The digital media 60 may be any of a variety of media, such as audio, video, and a combination of the two. Examples of digital media 60 include music (including a single song or a collection of songs, such as an album), audio books, movies, television programs, radio broadcasts, and the like. The digital content 60 may also be software or other fungible commodities that are available in digital form. The database 50 may be a server, a desktop or laptop computer, or other processor-based system having non-volatile media storage capability, such as a SCSI (small computer systems interface) hard disk drive. The database 50 is accessible to the consumer 80 by way of the communications portal 36.

The communications portal 36 is part of a global network computing system 54, which may be an Internet-based network, a proprietary wide-area network (WAN), a local-area network (LAN), and so on. In some embodiments, the global network computing system is the World Wide Web. The communications portal 36 is a mechanism by which the consumer 80 accesses the digital media database 50. The communications portal 36, for example, may be a graphical user interface (GUI), such as a web page on the World Wide Web or other network.

The communications portal 36 further includes a choosing mechanism 38, which enables the consumer 80 to select digital content 60 from the digital media database 50. Accordingly, the choosing mechanism 38 may includes graphical icons of the digital media 60, a tabulated listing of the digital media, other indicia of the content of the digital media database 50. Software programmers and web designers of ordinary skill in the art recognize a number of possible implementations of the choosing mechanism 38, for communicating available selections of digital media 60 to the consumer 80.

The media download system 100 also includes the rightsholders' administrator 70, which operates as an agent for the rightsholders 40. The rightsholders 40 are the owners of the copyright to the digital media 60, and may include artists, musicians, producers, and the like. (The rightsholders 40 may also include licensees of the original copyrightholder.) The rightsholders' administrator 70 may include a traditional agent for rightsholders, such as those for the music industry, ASCAP (American Society of Composers, Authors, and Publishers), EMI, and those for the movie industry, Warner, Universal, Sony BMG, to name a few.

Each digital medium 60 may be subject to restrictions of a license by a rightsholder, such as a copyrightholder of a musical piece. Typically, the license specifies that the rightholder is to be paid a royalty for the content, whether the content is sold, played on the air, downloaded, and so on. The rightsholders' administrator 70 ensures that the rightsholders 40 obtain royalties in accordance with the terms of license agreements signed by the rightsholders and their representatives. It is the rightsholders' administrator 70, and not the rightsholders 40, who makes the artists' work product (music, video, etc.) available to the public for consumption.

The media download system 100 also includes a retailer/sponsor 30, which may be a retailer, a sponsor, or both. The retailer/sponsor 30 pays royalties 42 to the rightsholders 40. The retailer/sponsor 30 also supplies coupons 90 to one or more of the consumers 80, known herein as a selected consumer 82 or winning customer. The selected consumer 82 may be determined in a variety of ways. The consumer may be selected at random, may represent a percentage of customers in a given time period, may represent a percentage of media downloads in a given time period, and so on. The issuance of a coupon 90 to the selected consumer 82 is intended to lure the customers 80 toward another transaction, a subsequent engagement with the retailer/supplier 30.

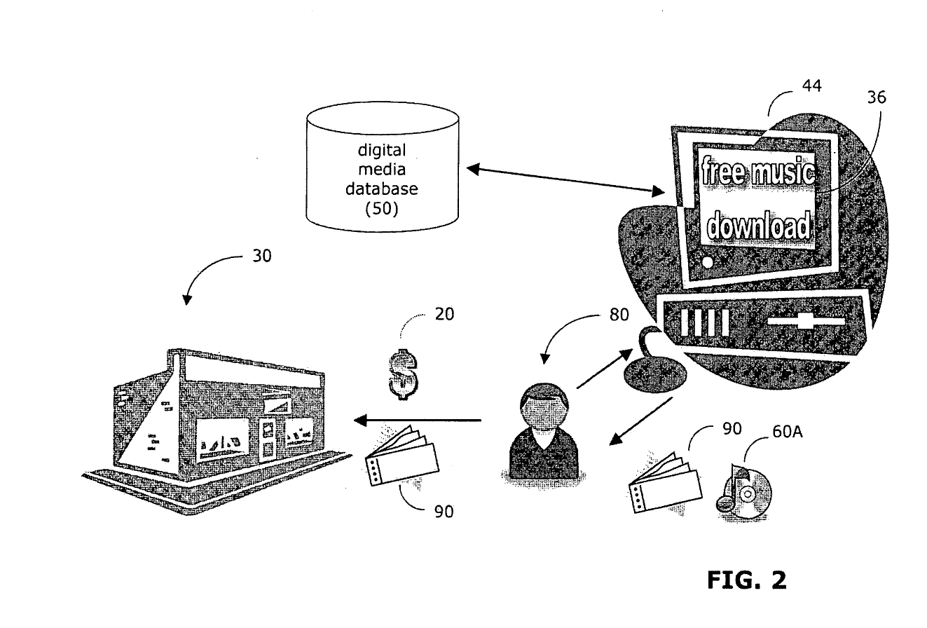

FIG. 2 is a depiction of the perspective of the consumer 80 in using the media download system 100. The consumer 80 accesses the communications portal 36, depicted as a web page on a computer screen, where the web page 36 is offering free, bulk, or low cost downloads of digital media from his computer 44. The computer 44 is connected to the global network computing system 54. The web page 36 presents the choosing mechanism 38 (not shown), such as a graphical presentation (e.g., icons) of the available digital content 60 stored in the digital media database 50. After accessing the web page 36, the consumer 80 selects the desired digital content 60, such as an audio music file 60A. (Although a compact disc is depicted in FIG. 2, the digital content 60 to be downloaded is likely one of several downloadable audio formats, see below.) Unbeknownst to the consumer 80, the system administrator 32 initiates operations to cause the music to be downloaded to the computer 44. This consumer 80 gets lucky, as he is one of the winning customers 82, a selected consumer who receives a coupon 90.

The retailer/sponsor 30 hopes that the consumer or consumer 80 will bring the coupon 90 to the store. The coupon 90 enables the consumer 80 to exchange the coupon for some hard-goods of the retailer 30. As used herein, hard-goods are distinguishable from the digital media to be downloaded. Hard-goods may, however, include audio content, such as music CDs, or video content, such as digital video discs (DVDs). Of course, there is no guarantee of this subsequent transaction between the consumer 80 and the retailer 30 taking place. Preferably, the coupon 90 has a value that is adequate to lure the consumer 80 to the store of the retailer/sponsor 30. (The store may be a physical structure of the traditional type, a brick-and-mortar retail store, or the store may be an online retailer.) The retailer/sponsor 30 is hoping that, in addition to bringing the coupon 90 to the store, the customer will also bring a little extra cash 20.

The retailer/sponsor 30 may be a company associated with the digital media 60 being downloaded. Thus, for example, where the consumer 80 downloads a Disney™ DVD, the retailer/sponsor 30 may be The Disney Store™, which may issue coupons 90 for The Disney Store™. Or, the relationship between the digital media and the retailer/sponsor 30 may be less related or have no relationship at all.

There are many web sites that offer free or inexpensive content with advertising. Sometimes, the advertising is scattered all over the web page. In other cases, the advertising is bundled with the desired content. Proceeds from the advertising are used to pay for the content. Whether the customer absorbs the advertising is difficult to ascertain. The benefit to the advertiser who paid for the content is tenuous. Prospective customers may even be turned off by the quantity of advertising banners, the “captive audience” manner in which the customer is forced to view the advertisement before the content, and other characteristics of the advertisement that the customer may regard as a nuisance.

By contrast, in the media download system 100, the retailer/sponsor 30 is able to specifically identify whether the coupons 90 are being used by the consumers 80. Each coupon 90 may have a unique identifier, such as an EAN (European Article Number) code, a UPC (Universal Product Code), or other indicia. The identifier may be tracked by the retailer 30, who may ascertain not only how many coupons were cashed and for what amount, but further obtains information about the consumer 80, such as the spending habits of the consumer, for example, how much additional money was spent. The coupons also inform the retailer about the music, video, or other digital media that was downloaded by the customer, which can further enhance the relationship between the retailer/sponsor 30 and the consumer 80.

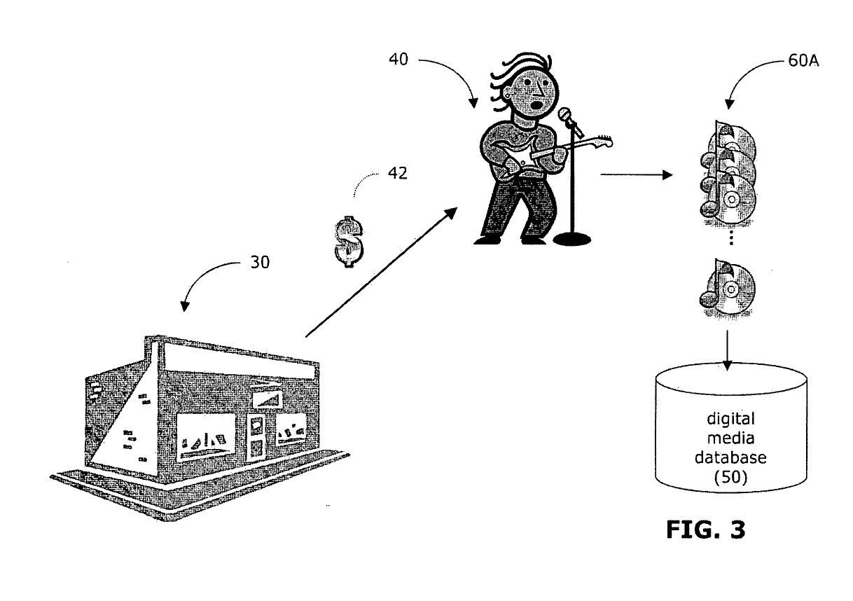

FIG. 3 is a depiction of the relationship between the retailer/sponsor and the copyrightholder 40, according to some embodiments. The retailer/sponsor 30 pays royalties 42 to the copyrightholder 40, shown as a musician. This motivates the rightholder 40 to submit his digital media works, shown as music CDs 60A (the digital media could also be .mp3 or .wma files, as two examples), to be stored in the database 50, so that more royalties 42 will be paid.

The digital media may be available in one or several forms. In some embodiments, the digital media is not protected using digital rights management, or DRM. The digital media may be in one of the known formats or may be available in a form not yet known, as long as the media may be transmitted across a network. Known digital formats include, but are not limited to mp4, mpeg, mpeg4, avc, wmv, avi, divx, aac, aiff, ac3, ogg, avi, mpg, mp3, mp4, asf, mov, 3gp, amr, flv, flic, swf, rm, and rmvb.

Referring again to FIG. 1, the retailer/sponsor 30 is shown submitting coupons 90 to the system administrator 32, for presentment to the selected consumer 82 and submitting royalties 42 to the rightholder 40 of the digital media 60. In some embodiments, the royalty 42 is paid to the rightholder 40 when the consumer 80 selects the digital media 60 for download (e.g., a piece license). In other embodiments, the royalty 42 is paid to the rightholder 40 when the digital media 60 is uploaded to the digital media database 50, in which a certain number of downloads of the digital media is presumed (e.g., a blanket license).

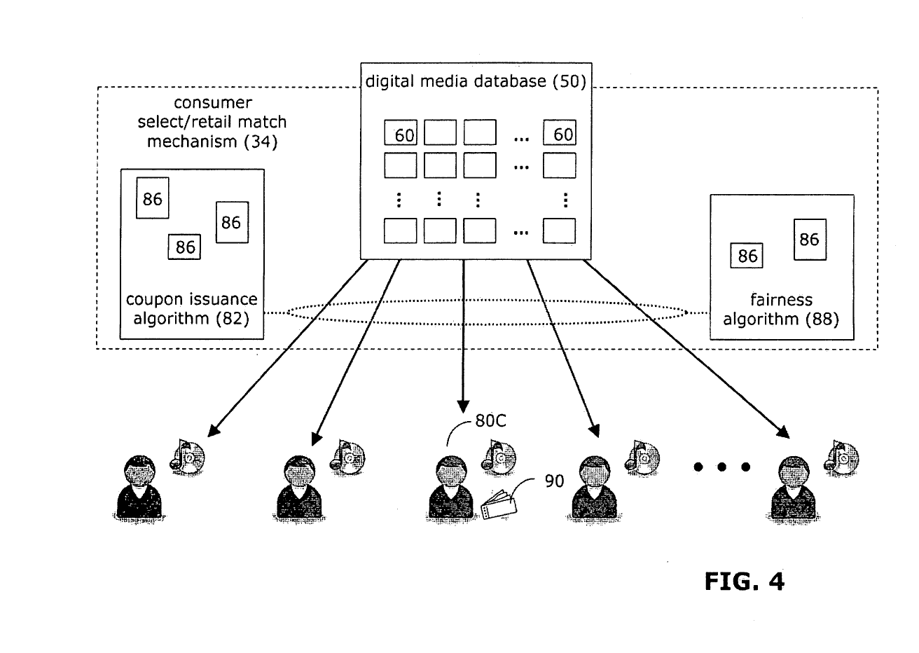

The consumer select/retail match mechanism 34 determines how the coupons 90 are distributed to selected consumers 82. FIG. 4 is a depiction of the mechanism used by the media download system 100 for ensuring that a desired number of coupons reach customers, according to some embodiments. The consumer select/retail match mechanism 34 includes a coupon issuance algorithm 82 and a fairness algorithm 88. Both operate as a filter between the digital media database 50 and the consumer 80. The coupon issuance algorithm 82 issues coupons to a selection of customers 80 according to preset criteria. Thus, for example, the coupon issuance algorithm 82 may issue a predetermined number of coupons 90 per day. Or, the number of coupons issued by the coupon issuance algorithm 82 may be based on the number of customers 90 who access the web site (a percentage, for example), the number of digital media instances 60 downloaded by customers (a percentage). Or, the coupon issuance algorithm 82 may increase the likelihood of winning a coupon for repeat customers, as another example.

The coupon issuance algorithm 82 may thus operate using parameters 86 that may be changed by an administrator of the media download system 100. For example, a percentage parameter may be adjusted, such as if the retailer/sponsor 30 wants more customers 80 to redeem the coupons 90 as part of a promotional event, or for other reasons. A region parameter may be specific to a region, allowing the media download system 100 to be adaptable to different consumer markets, such as different countries. An IP address parameter may indicate specific geographic regions. Additional parameters may be defined and thereafter may be updated, so as to maximize the flexibility of the consumer select/retail match mechanism 34.

In addition to having the coupon issuance algorithm 82, the consumer select/retail match mechanism 34 further includes the fairness algorithm 88, to ensure “fairness” of the system, in some embodiments. Thus, to avoid “stealth” operations, in which a single consumer 80 accesses the web site multiple times, an identification, or ID, is associated with every consumer 80. The ID may be an email address, an internet protocol, or IP, name or address of the consumer, bulk- or discount member number, or may conform to some future identification, recognition, or verification mechanism. The ID may be printed on the coupon itself or stored by the fairness algorithm 88 for a predetermined time period, say twenty-four hours. When the consumer 80 accesses the web site, the fairness algorithm 88 checks the ID, so as to prevent customers 80 from accessing the web site more than once over the time period. When the vendor is a brick-and-mortar establishment and the coupon includes the ID printed thereon, an employee of the vendor may visually confirm that the person presenting the coupon is indeed the person to whom the coupon was issued.

The fairness algorithm 88 is also intended to eliminate automatically generated login or similar methods, in which software, rather than individual persons, are used to access a web site. For maximum flexibility, the fairness algorithm 88 may also use parameters 86. The consumer select/retail match mechanism 34 may be implemented using software, hardware, or a combination of the two.

In some embodiments, the consumer 80 submits identifying information, such as name and electronic mail (email) address, each time the web site 46 is entered, for example, and responds to an activation email before being given the right to access using a user name and password. The consumer 80 may revisit the web site 36 again and again, as long as the visits are in compliance with the fairness algorithm 88. Thus, for example, where the web site 36 allows a consumer 80 to download music once a day, then the consumer 80 will be allowed access to the digital media database 50 once per day.

Once the consumer 80 enters the communications portal 36, the client may access the digital content 60 of the digital media database 50. The digital content 60 may include movies, songs, spotlights on particular artists, software, etc. In some embodiments, the digital content 60 includes an associated preview function. So, for example, an audio file, such as a featured song may include the capability for the consumer 80 to listen, or sample, to the music prior to performing the download operation. Similarly, software to be downloaded may include screen shots that may be previewed by the consumer 80.

When the consumer 80 is selected by the consumer select/retail match mechanism 34 to receive a coupon 90, known as a selected consumer 82, the consumer is prompted for contact information, namely, an address to where the coupon may be sent. The coupon 90 is sent to the consumer 80 using traditional postal services. In an alternative embodiment, the coupon 90 may be viewable on the web page 46 for printing by the customer. An identifying mark, such as an EAN code, a UPC, or the like, may be added to the online-viewable coupon, enabling the vendor at the retailer/sponsor 30 store to properly validate the coupon. As another option, the consumer 80 may be prompted to supply an email address, such that the consumer select/retail match mechanism 34 sends the coupon 90 by way of electronic mail. Or, the coupon 90 may be presented on the web page immediately, to be printed by the consumer 80.

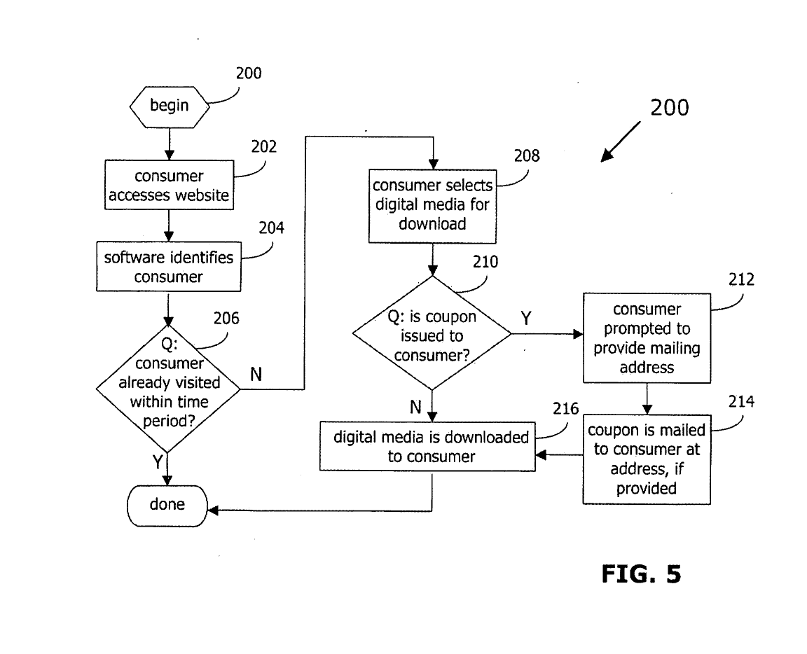

FIG. 5 is a flow diagram depicting operations 200 performed by the media download system 100, according to some embodiments. The download process 200 begins when the consumer 80 accesses the communications portal 36 (block 202). The portal 36 may be operated by the system administrator 32 under the direction of the retailers/sponsor 30, by the rightsholders' administrator 70, or may be independent. The consumer 80 may enter the portal 36 using a computer 44 (FIG. 2), a hand-held device, a cellphone, a mobile-player with Internet access, or using some other means to access the portal 36. In some embodiments, the portal 36 is a web page having an associated uniform resource locator (URL).

The consumer 80 is identified by the consumer select/retail match mechanism 34, such as by requesting and obtaining an email address and password of the consumer 80 (block 204). If the consumer 80 has already visited within the allowed time period (block 206), additional website accesses are not possible, and the operations cease. The fairness algorithm 88, described above, arbitrates whether the consumer 80 is granted access or simply whether the consumer 80 may be eligible to win another coupon. (Such may optionally be presented via a popup window upon a further visit.) In some embodiments, the time period is twenty-four hours. A message may be displayed on the web page 36, indicating the prohibition to the customer, with an invitation to revisit the site at a later time.

If, instead, the consumer 80 is identified as not having visited the site within the predetermined time period, the customer is invited to select a desired digital media 60 for download (block 208). If the customer ends up being one of the customers selected by the coupon issuance algorithm 82 (block 210), the customer is prompted to provide a mailing address (block 212), so that a coupon 90 may be mailed to him (block 214). (If the mailing address is the same as a previous winner, a disqualification window may open.) In some embodiments, the mechanism 34 enables the consumer 80 to bypass the coupon issuance process. Once the customer has provided his contact information, the music is downloaded to the computer 44 of the consumer 80 (block 216).

The media download system 100 is advantageous over the prior art in several ways. For one, coupons are attractive to many consumers. The coupons 90 may be custom-provided such that, for example, coupons for certain retail establishments are made available when a certain type of music is downloaded, with the coupons varying for punk, country, rock, jazz, classical, and so on. There may also be a segmentation of coupons, in which a more valuable coupon is available for every 100, 1000, or 10,000 smaller-valued coupons issued. The coupons 90 may also be demographically smart. That is, coupons may be country-specific, region-specific, IP-address specific, and not simply one-size-fits-all coupons. The objective of the retailer/sponsor 30 is to get as many customers 80 to use the coupons 90 in their brick-and-mortar establishments or at their online web sites, and, hopefully, engender goodwill with the customers.

Further, coupons may be attractive to the customer in ways that advertising is not. A consumer may opt to avoid a digital media offer that requires her to view a commercial, for example. Relative to advertising, coupons are a low-pressure incentive that will motivate some customers (those that clip coupons regularly, for example), but will not put off other customers (who may simply ignore the coupon mailed to them). In contrast to advertisements, the coupon 90 may attract many more consumers 80 to a retail establishment, which will motivate the retailer/sponsor 30 to continue to support the system 100 by continuing to pay royalties 42, and by encouraging more artists to provide their digital content 60 to the database 50.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

What is claimed is:

1. A media download system, comprising:
a digital media database, the database being stored, each digital medium of the digital media database being subject to restrictions of a license of a rightholder;
a retailer who contracts to pay a royalty to each rightholder under the license, the retailer further supplying a coupon to a selected consumer who downloads a select digital medium from the database, the coupon being redeemable at a store;
a web page accessible by a consumer on a computer, the web page providing a view of the database, wherein the consumer:
selects a digital medium from the database; and
downloads the digital medium to the computer, wherein a routine is included to determine whether the consumer is to receive a coupon and, if so, preparing and sending the coupon to the customer.

2. The media download system of claim 1, further comprising:
a match mechanism to determine which of a plurality of consumers visiting the web page is the selected consumer.

3. The media download system of claim 2, wherein the match mechanism further:
identifies the consumer accessing the web page; and
prevents the consumer from downloading a selected digital medium if the consumer has accessed the web page within a predetermined time period.

4. The media download system of claim 3, wherein the predetermined time period is twenty-four hours.

5. The media download system of claim 3, wherein the selected consumer further:
obtains the coupon from the retailer; and
redeems the coupon at a store specified by the coupon.

6. The media download system of claim 5, wherein the store is a brick-and-mortar building.

7. The media download system of claim 5, wherein the store is a web site.

8. A method for performing media download, the method comprising:
presenting a web page viewable by a consumer on a computer, wherein the computer is connected to a global network computing system, the web page comprising a choosing mechanism for selecting the downloadable digital media;
screening the consumer based on an internet protocol address of the computer, access to the web page being ceased if the consumer has accessed the web site within a predetermined time period;
receiving a selection of digital media to be downloaded from the consumer;
issuing a notification to the consumer, the notification indicating that the consumer has won a coupon issued by a retailer, the retailer to further pay royalties to rightsholders of the downloadable digital media;
requesting the consumer to supply contact information, wherein the coupon is presented to the consumer via the contact information; and
enabling the consumer to download the selected digital media to the computer.

9. The method of claim 8, screening the consumer based on an electronic mail address and password of the consumer, access to the web page being ceased if the consumer has accessed the web site within a predetermined time period further comprising preventing access to the web page if the consumer has accessed the web site within twenty-four hours.

10. The method of claim 9, further comprising:
sending the coupon to the consumer via regular postal mail.

11. The method of claim 9, further comprising:
transmitting the coupon to the consumer via electronic mail.

12. The method of claim 9, further comprising:
enabling the consumer to bypass the coupon issuance.

13. A coupon-based digital content and hard-goods exchange system, comprising:
a system administrator, comprising:
a digital media database, comprising a plurality of digital content items stored in the database, with each digital content item of the database being separately accessible; and
a consumer selection and retailer matching mechanism;
a communications portal accessible to a plurality of consumers via a global network computing system;
a retailer providing consideration to the system administrator, the consideration comprising a retailer coupon issuable to a consumer upon selection of the consumer from the plurality of consumers and matching the consumer to the retailer;
a choosing mechanism to allow the consumer to choose a digital content item from the plurality of digital content items, the system administrator to:
process a choice made by the consumer via the portal; and
enter consumer information into the consumer selection and retailer matching mechanism;
wherein the retailer coupon, generated by the consumer selection and retailer matching mechanism, is sent to the selected consumer, the retailer coupon exchangeable at least in part for a hard-good of the retailer.

14. The coupon-based digital content and hard-goods exchange system of claim 13, the consideration further comprising:
a royalty payment to a rightholder of a digital content item of the plurality of digital content items.

15. The coupon-based digital content and hard-goods exchange system of claim 14, wherein the royalty payment is made when the digital content item is selected by the consumer, the royalty payment to be made to the rightholder of the digital content item.

16. The coupon-based digital content and hard-goods exchange system of claim 14, wherein the royalty payment is made when the digital content item is uploaded to the digital media database

17. A computerized method encoded on a computer-readable medium, the method comprising:
instructions for presenting a web page viewable by a consumer on a computer, wherein the computer is connected to a global network computing system, the web page comprising a choosing mechanism for selecting the downloadable digital media;
instructions for screening the consumer based on an internet protocol address of the computer, access to the web page being ceased if the consumer has accessed the web site within a predetermined time period;
instructions for receiving a selection of digital media to be downloaded from the consumer;
instructions for issuing a notification to the consumer, the notification indicating that the consumer has won a coupon issued by a retailer, the retailer to further pay royalties to rightsholders of the downloadable digital media;
instructions querying the consumer to supply contact information, wherein the coupon is presented to the consumer via the contact information; and
instructions enabling the consumer to download the selected digital media to the computer.

18. The method of claim 17, screening the consumer based on criteria, such as by an electronic mail address and/or password of the consumer, access to the web page being ceased if the consumer has accessed the web site within a predetermined time period further comprising preventing access to the web page if the consumer has accessed the web site within twenty-four hours.

19. The method of claim 18, further comprising:
sending the coupon to the consumer via regular postal mail.

20. The method of claim 18, further comprising:
transmitting the coupon to the consumer via electronic mail.

21. The method of claim 18, further comprising:
enabling the consumer to bypass the coupon issuance.

22. A computer-readable medium encoded with a computerized method, the method comprising:
instructions for presenting a web page viewable by a consumer on a computer, wherein the computer is connected to a global network computing system, the web page comprising a choosing mechanism for selecting the downloadable digital media;
instructions for screening the consumer based on an internet protocol address of the computer, access to the web page being ceased if the consumer has accessed the web site within a predetermined time period;
instructions for receiving a selection of digital media to be downloaded from the consumer;
instructions for issuing a notification to the consumer, the notification indicating that the consumer has won a coupon issued by a retailer, the retailer to further pay royalties to rightsholders of the downloadable digital media;
instructions querying the consumer to supply contact information, wherein the coupon is presented to the consumer via the contact information; and
instructions enabling the consumer to download the selected digital media to the computer.

23. The method of claim 22, screening the consumer based on criteria, such as by an electronic mail address and/or password of the consumer, access to the web page being ceased if the consumer has accessed the web site within a predetermined time period further comprising preventing access to the web page if the consumer has accessed the web site within twenty-four hours.

24. The method of claim 23, further comprising:
sending the coupon to the consumer via regular postal mail.

25. The method of claim 23, further comprising:
transmitting the coupon to the consumer via electronic mail.

26. The method of claim 23, further comprising:
enabling the consumer to bypass the coupon issuance.

27. The media download system of claim 1, wherein the preparing of the coupon includes integrating an ID, such as a user name or member number, into the coupon so that an employee at the brick-and-mortar establishment can verify the identity of the consumer presenting the coupon, prior to allowing use of the coupon.
